(19) United States
(12) Patent Application Publication
(10) Pub. No.: US 2007/0006153 A1
(43) Pub. Date: Jan. 4, 2007

(54) Extensible testing framework

(75) Inventor: Hassan Sultan, Seattle, WA (US)

Correspondence Address: BANNER & WITCOFF LTD.,;ATTORNEYS FOR CLIENT NOS. 003797 & 013797, 1001 G STREET , N.W., SUITE 1100, WASHINGTON, DC, 20001-4597, US

(73) Assignee: Microsoft Corporation, Redmond, WA (US)

(21) Appl. No.: 11/136,390

(22) Filed: May 25, 2005

(51) Int. Cl. G06F 9/44

(52) U.S. Cl. 717/124

(57) ABSTRACT

Methods and systems for providing an extensible testing framework are provided. An extensible testing framework may use field objects to represent test data values of various data types, including char, int, string, and the like. The framework is extensible in that new field objects may be added as new data types are needed during testing. The extensible testing framework may use transport objects to communicate test values to and from the target software being tested, e.g., using TCP Client, TCP Server, UCP Client, and the like. The framework is extensible in that new transport objects can be added as new transport protocols are needed, e.g., for a command line interface. Each test executes under the control of a test manager, as defined by configuration information provided in a configuration file or via an external executable control application.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The invention relates generally to computer software and software development. More specifically, the invention relates to an extensible framework for testing software programs, and to detect and identify potential input and output errors in the software programs.

### BACKGROUND OF THE INVENTION

Security breaches of software are, unfortunately, a not too uncommon occurrence. Bugs and other failures to handle normal and exceptional conditions during execution of software can result in substantial harm to the software owner or provider, including financial losses, damage to property, and even loss of life, depending on the failure and the type of software.

In order to identify bugs in software prior to the general release of the software by the software developer or publisher, programmers often use one or more software testing applications to identify and fix errors. Software test applications are used to attempt to identify and fix bugs during the development process, before the software is put in production. However, known test applications are limited in their capabilities in that they are not easily modifiable. When a new type of data is defined or created, the software test application must be substantially rewritten to handle the new type of data. In addition, known software testing applications do not effectively test the handling of user input, especially when some user input is based on previous output provided by the software being tested or invalid. That is, most software failures occur due to faulty handling of user input, however, not all test applications effectively test the handling of user input.

Thus, it would be an advancement in the art to address the above concerns, e.g., by providing an extensible test application that more thoroughly tests the handling of user input, and allows for input tests based on previous output.

### BRIEF SUMMARY OF THE INVENTION

The following presents a simplified summary of the invention in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

To overcome limitations in the prior art described above, and to overcome other limitations that will be apparent upon reading and understanding the present specification, the present invention is directed to an extensible framework for testing input and output of a target software program, the extensible framework including a plurality of field objects, each field object representing a data type usable with the target software, and at least one transport object providing a type of communication channel for communicating a field value of one or more of the plurality of field objects with the target software.

Users may define field objects for any data type needed for testing of the target software program, and may further define transport objects for any communication channel needed to communicate with the target software program. In addition, a user may specify a test to perform on the target software using field values of the field objects communicated over communication channels defined by transport objects. Each test may be defined in a configuration file or in an executable control program.

According to various aspects of the invention, a field value of a field object may be calculated based on another field object, e.g., based on the field value of the other field object, or based on a property of the other field object. A sequence field object may be used to represent a packet having multiple input fields, each of the same or different data types.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 illustrates an example of a suitable operating environment in which one or more illustrative aspects of the invention may be implemented.

FIG. 2 illustrates a block diagram of a software architecture which may be used according to one or more illustrative aspects of the invention.

FIG. 3 illustrates a block diagram of a field object according to one or more illustrative aspects of the invention.

FIG. 4 illustrates a Sequence Field Object (SFO) according to one or more illustrative aspects of the invention.

FIG. 5 illustrates a sample document type definition (DTD) file according to one or more illustrative aspects of the invention.

FIGS. 6A and 6B illustrate a sample XML configuration file according to one or more illustrative aspects of the invention.

FIGS. 7A and 7B illustrate another sample XML configuration file according to one or more illustrative aspects of the invention.

FIG. 8 illustrates a sample external executable control program according to one or more illustrative aspects of the invention.

### DETAILED DESCRIPTION OF THE INVENTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope of the present invention.

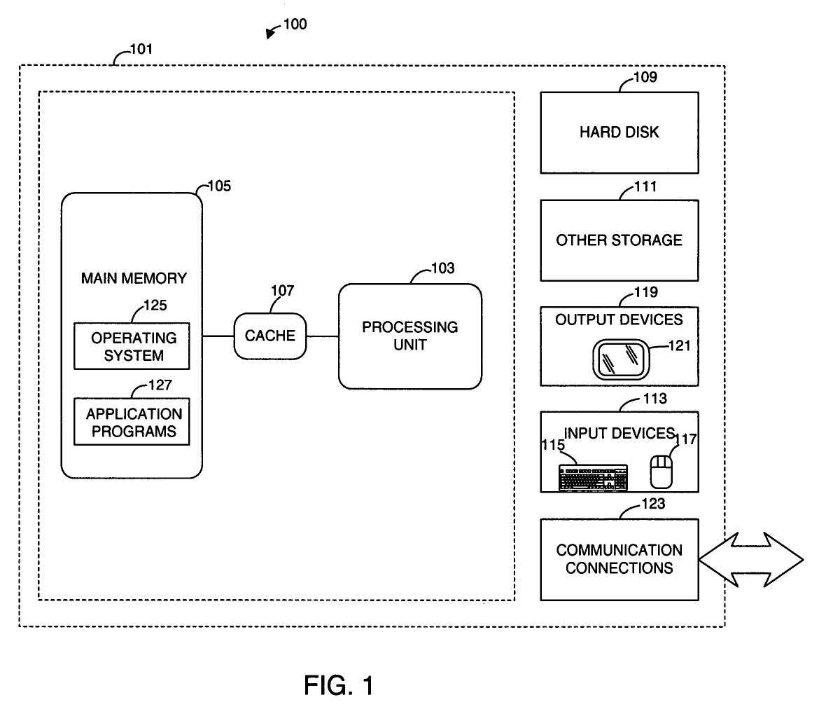

An example of a suitable operating environment 100 in which various aspects of the invention may be implemented is shown in the highly simplified schematic diagram in FIG. 1. The features of such environments are well-known to those having skill in the art and need not be described at length here. The operating environment 100 is only one example of a suitable operating environment and is not intended to suggest any limitation as to the scope of use or functionality of the invention. Suitable computing environments for use with the invention include any computing device or computing system that supports interaction between user and machine, e.g., including but not limited to desktop computers, laptop computers, palmtop computers, smart phones, personal digital assistants, mobile telephones, and the like.

With reference to FIG. 1, an illustrative system for implementing the invention includes a computing device, such as device 101. Device 101 typically includes at least one processing unit 103 and main memory unit 105, and at least one level of cache memory 107 connected to or situated within the processing unit 103 and serving as a buffer for the main memory 105. Device 101 has additional storage, including at least one magnetic hard disk 109 that serves as nonvolatile secondary storage and which is additionally used along with the main memory 105 in providing virtual memory. Device 101 may also have other storage 111, such as optical disks, removable magnetic disks, magnetic tape, and other removable and nonremovable computer-readable media capable of nonvolatile storage of program modules and data and accessible by device 101. Any such storage media may be part of device 101. To facilitate user-machine interaction, device 101 has input devices 113, such as a keyboard 115 and a mouse 117 or other pointing device (e.g., a stylus and digitizer in a tablet PC environment), and output devices 119, including a monitor or other display device 121. Device 101 also typically includes one or more communication connections 123 that allow the device to communicate data with other devices.

Programs, comprising sets of instructions and associated data for the device 101, are stored in the memory 105, from which they can be retrieved and executed by the processing unit 103. Among the programs and program modules stored in the memory 105 are those that comprise or are associated with an operating system 125 as well as application programs 127. The device 101 has one or more systems of logical data storage, such as a file system or alternative systems using database-related techniques, associated with the operating system 125. Such systems of logical data storage serve as interfaces that map logically-organized data to data physically located on secondary storage media, such as data stored in clusters or sectors on the hard disk 109.

Computing device 101 includes forms of computer-readable media. Computer-readable media include any available media that can be accessed by the computing device 101. Computer-readable media may comprise storage media and communication media. Storage media include volatile and nonvolatile, removable and non-removable media implemented in any method or technology for storage of information such as computer-readable instructions, object code, data structures, program modules, or other data. Communication media include any information delivery media and typically embody data in a modulated data signal such as a carrier wave or other transport mechanism.

The use of the terms “a,”, “an” and “the” and similar referents in the context of describing the invention, especially in the context of the following claims, is to be construed to cover both the singular and the plural, unless otherwise indicated herein or clearly contradicted by context. The terms “comprising,” “having,” “including,” and “containing” are to be construed as open-ended terms (meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. The use of any and all examples, illustrations, and/or exemplary language herein (e.g., “such as”) is intended merely to better illuminate the invention and does not pose a limitation on the scope of the invention unless otherwise claimed. No language in the specification should be construed as indicating any non-claimed element as essential to the practice of the invention.

Aspects of the invention provide a framework within which software developers can define, create and perform tests regarding the handling of user input by software. User input may be viewed as a collection of different types of data which, when put together as a whole, constitutes the data entered by a user of a software application. Aspects of the invention automatically simulate user input by creating semi-random, or fuzzy, data within prescribed constraints and providing the data as input to software in order to test the software's handling of user input. Thus, aspects of the invention simplify and speed up the software development cycle by providing an extensible set of objects to test common data types and the infrastructure to easily add support for new data types and new communication channels with which input and output can be communicated to the software.

Input may be described as a frame of data fields, with each data field having any of a variety of different data types, e.g., 32-bit integers, strings, GUIDs, IP Addresses, etc. Object classes may be used to blur input value ranges based on predefined criteria. The input value constraints may be provided by a tester (e.g., a user) to create useful malformed data values instead of merely relying on random data generation. Malformed data, as used herein, refers to any test data based on the type of data being tested, including random data, invalid data, data inside and outside of valid data ranges, and any other data used for testing.

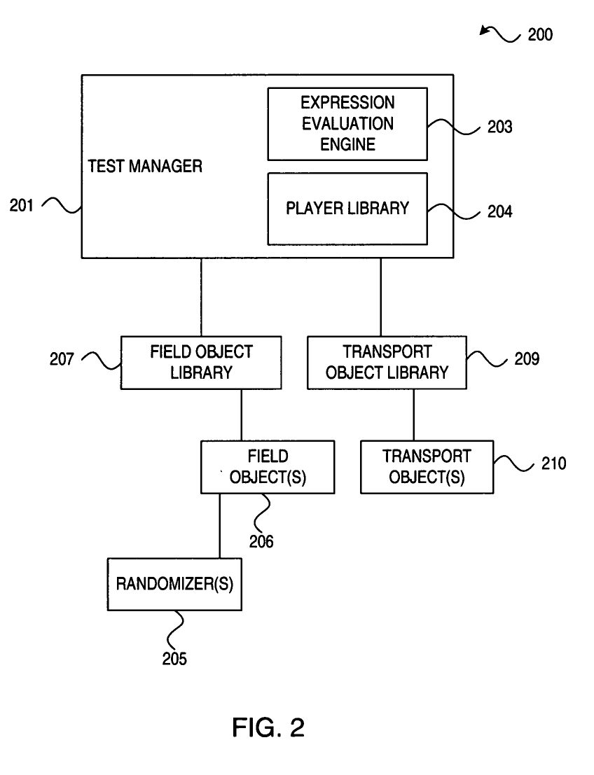

FIG. 2 illustrates a software architecture for an extensible test application 200 according to one or more illustrative aspects of the invention. A test manager 201 manages the overall testing process as defined by the user, further described below. The test manager 201 may incorporate an expression evaluation engine (EEE) 203, which may be used to evaluate values of objects at runtime based on mathematical expressions. EEE 203 may be extensible to allow evaluating expressions on different data types such as integers, strings, and the like. Mathematical expressions may refer to the current value of an object, or some property of an object. For example, given Sample Equation 1:
A*2+B/4−(C@length*5+3*C@charcount) (Sample Equation 1)

A, B, and C are object names and, when used alone, represent the current value of the named object as described below. C@length and C@charcount are properties of the object C which, if of the type string, represent the length in bytes of the current value and number of characters contained in the current value, respectively. Those of skill in the art will appreciate that EEE 203 may be adapted to support mathematical expressions for strings and numerical type values, as well as other data types.

Test manager 201 may process test instructions using player library 204. The player library 204 handles the loading of a user-specified test and the playing of that test, as further described below. Player library 204 may include multiple objects, e.g., C++ objects, to result in the behavior described herein.

Test manager 201 performs testing based on one or more field object libraries 207, and one or more transport object libraries 209. A field object library 207 references a plurality of randomizers 205 and a plurality of field objects 206. Each field object 206 within field object library 207, generally, generates data values based on the format of the data type and other parameters further described below. Each randomizer 205, generally, creates semi-random data for a data type based on specified criteria. Each transport object library 209 stores a plurality of transport objects 210. Each transport object 210 within transport object library 209, generally, provides for the sending and receiving of data over a transport protocol to and from the software being tested (also referred to as the target software).

A user can specify which transport objects to use depending on the communication methods with which a user communicates with the target software. That is, each transport object provides a framework to abstract a transport protocol through which the data is communicated with the target software. Transport protocols may include any communication mechanism, e.g., TCP, UDP, Internet protocols, named pipe local interprocess communication, command line console, etc. Transport object library 209 therefore may include a transport object corresponding to each of the communication mechanisms, and may optionally include a separate transport protocol for sending and receiving over the same communication mechanism. Each transport object may be based on a transport base class, and provide normalized interfaces and functionality including:
Functionality and normalized interfaces to read parameters from an XML configuration file;
Create a communication channel;
Close a communication channel;
Send a specified amount of data on the communication channel;
Read a specified amount of data from the communication channel;
An in-memory transport class database in which transport-based classes register to inform the framework of their availability and allow dynamic reuse as well as methods to access the transport class database; and
An in-memory transport instance database in which instances of transport-based classes register to allow the framework and the user to locate transport objects at any time, based on their names as well as methods to access the transport instance database.

In one illustrative embodiment of the invention, there are separate transport objects for sport protocols including TCP Client, TCP Server, UDP Client, named pipe client connections, file reading/writing, and command line console writing. Each transport object may have parameters and/or properties based on the needs of the transport protocol, e.g., IP Address (destination and source), Port (destination and source), Client Port, Socket Option, File Name, Attributes, etc. Those of skill in the art will appreciate that, given the extensible nature of the debugging framework described herein, other transports may be added simply by adding a transport object written to handle the desired communication mechanism.

Field object library 207 provides a framework for representing different types of data that can be used a user input or received as output. Field object library 207, for each represented data type, stores at least one field object 206, which may include one or more randomizer objects 205 (also referred to simply as “randomizer”). A data type may have more than one field object, as further described below. Each randomizer 205 is used by field object 206, field object library 207 and test manager 201 to create semi-random test data values. The test data values are referred to as semi-random because the test data values may be based on criteria specified by the tester (e.g., the user), further described below. For example, a DomainNameRandomizer may create any number of semi-random domain names based on values set by the tester, e.g., length, top-level domain (TLD), variants, etc. An IPAddressRandomizer may create semi-random IP addresses based on values set by the tester, e.g., IPv4, IPv6, IP range, etc. Randomizers may be included, e.g., for data types including unsigned int64, signed int64, unsigned int, signed int, unsigned short int, signed short int, unsigned char, signed char, IP Address (IPv4), IP Address (IPv6), filename, filepath, domain name, object identifier, string, telephone number, zip code, or other desired user inputs.

Each field object 206 formats the test data as it should be provided to the target software. When a data type may be provided in two different formats, then two different field objects may be used. For example, an IPAddressFieldObject may format an IP Address value in the standard 4 bytes format used to represent IP addresses in the IP protocol header and an IPAddressStringFieldObject may format an IP Address value in the standard text format used to represent IP addresses in HTTP urls, ping.exe command line parameters, and the like. In one embodiment of the invention, field object library 207 may include a field object 206 for each of: unsigned 8 byte integer, signed 8 byte integer, unsigned 4 byte integer, signed 4 byte integer, unsigned 2 byte integer, signed 2 byte integer, unsigned 1 byte integer, signed 1 byte integer, IP address (4 bytes IPv4/16 bytes IPv6 format), IPv6/IPv4 address string (UTF8/UCS2/ANSI string formats), domain name string (UTF8/UCS2/ANSI string formats), filename string (UTF8/UCS2/ANSI string formats), filepath string (UTF8/UCS2/ANSI string formats), object identifier string (UTF8/UCS2/ANSI string formats), raw data, asn BER encoding integer, asn BER encoding octet string, asn BER encoding object identifier, asn BER encoding null, asn BER encoding sequence, asn BER encoding SNMP PDU, array (of objects of the same type preceded by a field specifying the length), and sequence (array of objects of different types).

The above listed field objects and randomizers may be included in an initial field object library. However, those of skill in the art will appreciate that additional randomizers and/or field objects may be added for other new or existing data types. For example, a user might create a field object representing an HTTP Content-Type header or an Ethernet MAC address, with corresponding randomizers, and store the new field objects and randomizers in the field object library for use during testing.

As discussed above, each randomizer determines semi-random values for use during testing. According to an aspect of the invention, each randomizer can generate test data including random values within a user-specific constraint, boundary values around one or more user-specified ranges or constraints, and known invalid values. The boundary values may include a random value larger than the upper boundary and a random value lower than the smaller or lower than the lower boundary. Boundary values refer to data values that are equal to and within one increment above and below a boundary. Thus, given the integer range 0-255, boundary values include −1, 0, 1, 254, 255, and 256. As another example, 3, 4, and 5 are boundary values of 4. The known invalid values may include values which are known to be invalid with respect to the format of the data type in question. For example known invalid values for an IP address string would comprise strings containing alphabetical characters.

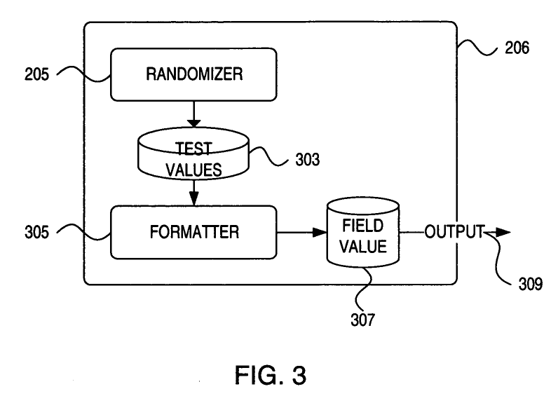

FIG. 3 illustrates a detailed block diagram of a field object 206. The field object base class may provide functionality and interfaces common to fields in a data flame. Objects for a specific data type can then be created and/or modified by deriving from the base class or a derived class and adding missing functionality or modifying existing behavior. The field object base class may provide the following base capabilities:
Functionality to name the object, e.g., StringFieldObject;
An in-memory class database in which FieldObject-based classes can register to inform the debugging framework of their availability and allow dynamic reuse as well as methods to access the in-memory database;
An in-memory instance database in which instances of FieldObject-based classes can register to allow the framework and the user to locate objects at any time based on their names as well as methods to access the in-memory database;
Normalized interfaces to retrieve the class type, class data type and object name of the field object;
Normalized interfaces to initialize the field object to the first value it contains in the test value store (described below) and set the object to the next value it contains;
Functionality and normalized interfaces to read parameters and values from an XML configuration file, including complete functionality handling the setting of parameters, storage of values and exclusion of values common to objects;
Normalized interfaces allowing dynamic access to properties exposed by the field object at runtime by looking up its name; and
Normalized interfaces to allow writing the data generated by the field object in an arbitrary Transport object and reading data of the specified field object's type from an arbitrary Transport object.

As discussed above, each field object 206 may optionally include (or alternatively refer to or call) one or more randomizers 205. Each randomizer (or field object) may further include a test values store 303, which stores all the test values through which the specific field object 206 will iterate during testing. Formatter 305 formats each test value into the proper format as expected by the target software. For example, formatter 305 may format a string into different character encodings for string type fields, different byte-ordering for integer type fields, etc., depending on the target software. Formatter 305 then saves the final form of the test value as field value 307, which may be output 309 by the field object for use as input to the target software via a transport object.

As discussed above, a user can specify values or ranges across which the randomizer automatically generates and stores test values. Each field object 206 need not necessarily include a randomizer 205, and may alternatively generate and store test values based on any user-provided functionality of the field object (e.g., a user writes special source code for the field object to generate test values according to some other criteria). In either scenario, with or without a randomizer, each field object preferably tests both valid and invalid input, and the invalid input is preferably based on the valid input.

According to an illustrative aspect of the invention, the test manager, or alternatively each field object, may expose one or more application programming interfaces (API) through which a user or other tester can instruct the field object to generate the test values, to iterate through test values, and otherwise communicate with the field object. Using the APIs, a tester can add specific and semi-random values to the test values store 303 of a field object 206. Each test value is then used during the iterative testing process, described further below.

A first API, referred to herein as AddUniqueValue(x), may be used to add a specific value x to a test value store 303 of a field object. A second API, referred to herein as AddRandomValue(x), may be used to add semi-random test values to store 303 based on the value x and based on the data type. A third API, referred to herein as AddRange(x,y), may be used to add the values (where x is less than y) x−1, x, y, and y+1 to the test values store 303, as well as add a random value between x and y, a random value well below x, and a random value well above y. A fourth API, referred to herein as AddSequence(x,y), may be used to add all values between x and y, inclusive, to test values store 303. A fifth API, referred to herein as AddPattern(x), may be used to add one or more test values based on a user-provided regular expression x, e.g., matching strings that follow some specified pattern x. A sixth API, referred to herein as AddVariable(x), may be used to add a test value resulting from a predefined mathematical expression x, or a test value calculated by EEE 203 (FIG. 2) based on a formula provided in a XML configuration file or source code under control of which the test manager (201) is operating, as further described below. For example, a user might specify that the resultant value of Sample Equation 1 should be added to a test value store 303 of a field object 206, where A, B, and C are field objects. Each of A, B, and C may store user-defined test values, or each may read an output value from the target software. The tester may use a seventh API to iterate a field object to a next test value in the test value store 303, e.g., using a GetNext( ) API. Other APIs may be used, and will become apparent to one of ordinary skill in the art upon reading the present description and viewing the provided code samples.

Because the target software might not only require user input, but might also provide usable output, one or more field objects may be instantiated to read output from the target software, and store the output for future use (e.g., in calculating a mathematical express as discussed above). A field object may expose a Read(x) API to read an output value transported by transport object x. The field object may validate the received data to confirm the received data is of the proper format of the type that the field object represents, and return an error if the received data is in an improper format. If the received data is of the proper format type, the field object formats the data according to its formatter 305 (FIG. 3), and stores the formatted received data as the current value 307 of the field object.

User input often includes more than one data type and value at a time. For example, the SNMP protocol defines an SNMP query packet as being a UDP packet including one asn encoded integer version field, one asn encoded community string field, and one asn encoded PDU field. Thus, according to an aspect of the invention a special field object may be used, referred to herein as a sequence field object (SFO), which may include any number of other field objects. An SFO may iterate through combinations of values for each field object housed by the SFO, creating all possible combinations of the generated values of the field objects stored therein.

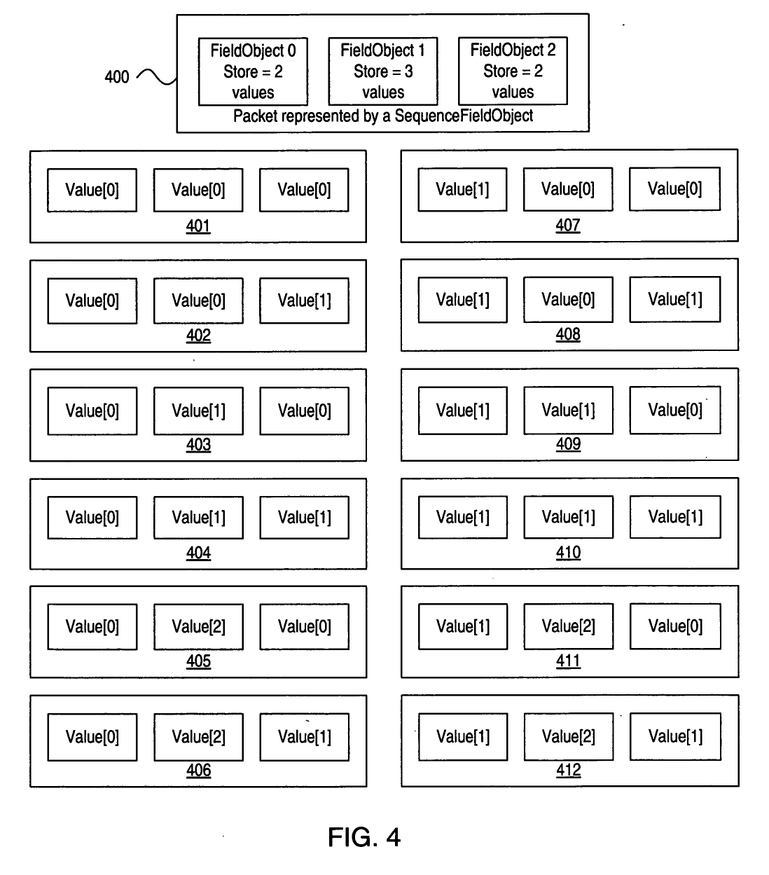

FIG. 4 illustrates a SFO 400 storing three field objects. The first field object, FieldObject 0, has two test values in its test value store. The second field object, FieldObject 1, stores three test values in its test value store. The third field object, FieldObject 2, stores two test values in its test value store. The twelve resultant states of SFO 400, illustrated as states 401-412, illustrate the SFO as it iterates through each combination of test values for each field object housed therein, e.g., as a result of the GetNext( ) API being called.

Using the above described framework, a software tester can specify data types, test input values and test input ranges to use during the testing process of the target software. The software tester can also specify transport protocols to use in communicating the test user input with the target software. A user may automate the process using any of at least two different mechanisms: a configuration file as input to an executable program, and a software control application which calls preexisting libraries. Those of skill in the art will appreciate that other control mechanisms may be used.

Thus, according to an aspect of the invention, a user may create an XML configuration file to automatically control operation of the testing process. A user can then execute the testing manager 201 from a command line prompt or operating system shell, providing the XML file as input. Test manager 201 may be an executable program which passes parameters to player library 204 based on the configuration file. Player library 204 may thus include functionality to:
Load a transport definition from the XML configuration file (two different transports may optionally be used for sending and receiving);
Load one or more test definitions from the XML configuration file;
Load packets used in the test definition from the XML configuration file; and
Play one or more tests defined by the configuration file and log the result of the test(s) in a log file.

Each configuration file defines one or more tests to perform on target software. A test, as referred to herein, refers to at least one communication channel defined by a transport object and a sequence of packets (defined by field objects) sent and/or received over the communication channel. Multiple communication channels may optionally be used. Each test, and each send and/or receive operation defined by the test, may have one or more optional parameters that a user can define. The XML configuration file may define the sequence of packets in a Tests section, and may define at least one communication channel in a Transports section. Test parameters may include a Repeat parameter, which specifies how many time the whole test should be repeated without changing the values in the fields of the packets, and an Iterations parameter, which specifies how many tests to run in a row over a single connection.

Each entry in the test section may be specified as a Send or Receive event. Each entry may include one or more parameters, such as a WaitTimeBefore parameter specifying the amount of time in milliseconds to wait before sending or receiving the packet, a WaitTimeAfter parameter specifying the amount of time in milliseconds to wait after sending or receiving the packet, a Repeat parameter specifying how many time the packet should be repeatedly sent/received (without updating the values in the packet), and an Iterations parameter specifying how many times the packet should be sent/received in a row (each time updating the values in the packet to the next available value from the value store). Thus, if a value store 303 stores, e.g., five test values, and the Iterations parameter is set to seven, then the test manger (or value store) may loop back to the first value at iteration six, and again proceed through the stored test values until the iterations have been completed. Other parameters may be used as well. In an alternative illustrative embodiment, the Iterations parameter might be unnecessary. In such an embodiment, the test manager may automatically determine how many test values are present in a value store 303, and may iterate through each value once. In yet another alternative illustrative embodiment, the Iterations parameter may refer to how many times the test manager should iterate through all test values in a test values store 303.

A Libraries section may be used to identify the libraries (e.g., DLL libraries) in which the transport and field objects to be used are stored. A Packets section may define or instantiate the objects to be used during the test, and a Descriptions section provides values to populate the objects with the test values to be used during the test. Thus, according to one illustrative embodiment, each configuration file may be formed according to the following XML format:
[Transports]
[Libraries]
[Tests]
[Packets]
[Descriptions]

When a test is run, a connection with the target software is established using a communication channel defined by a transport object, and the sequence of packets is sent and received as defined by the test. The connection is preferably closed upon completion of the test.

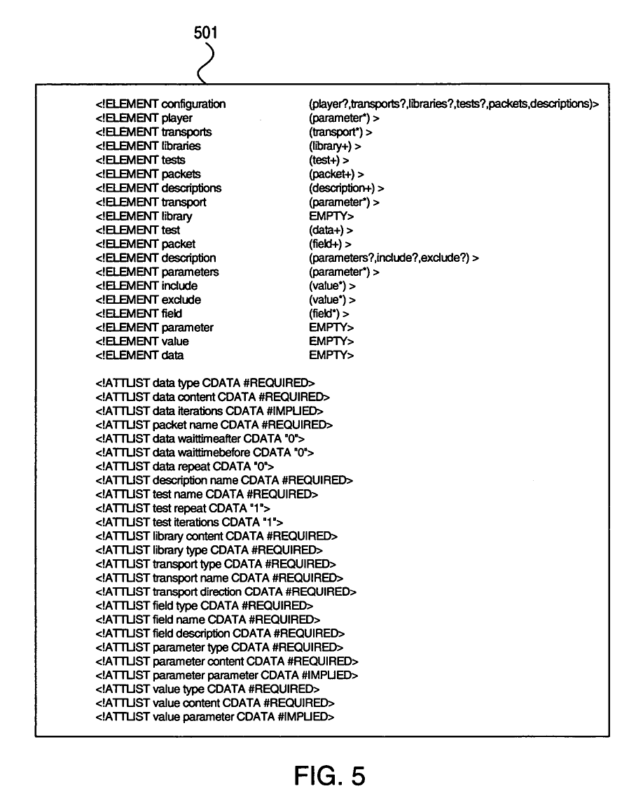

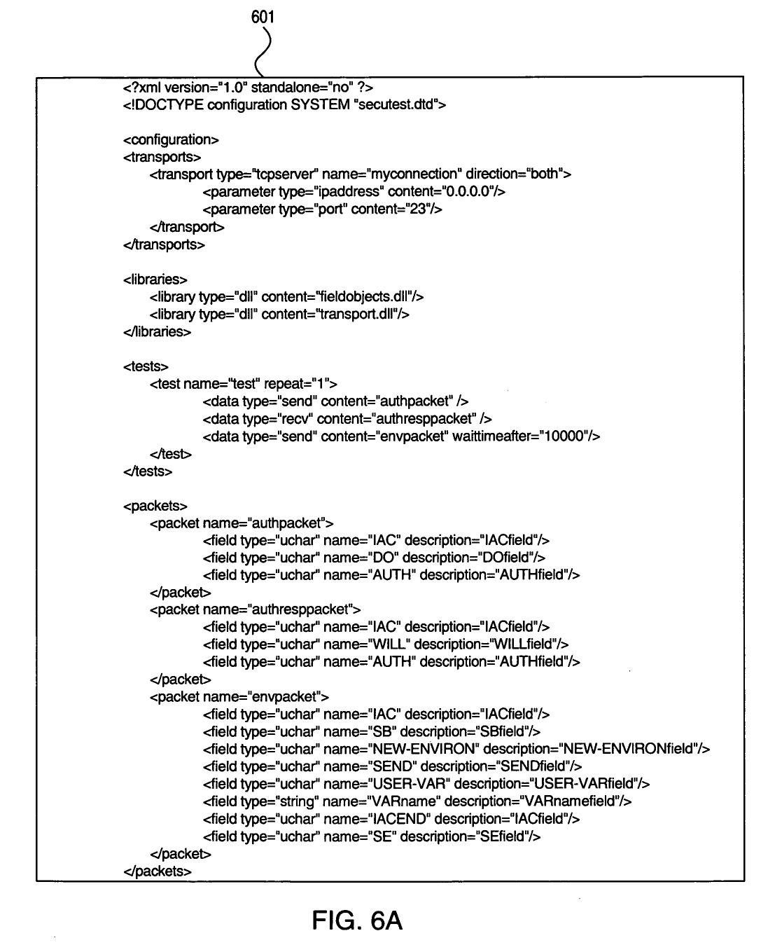

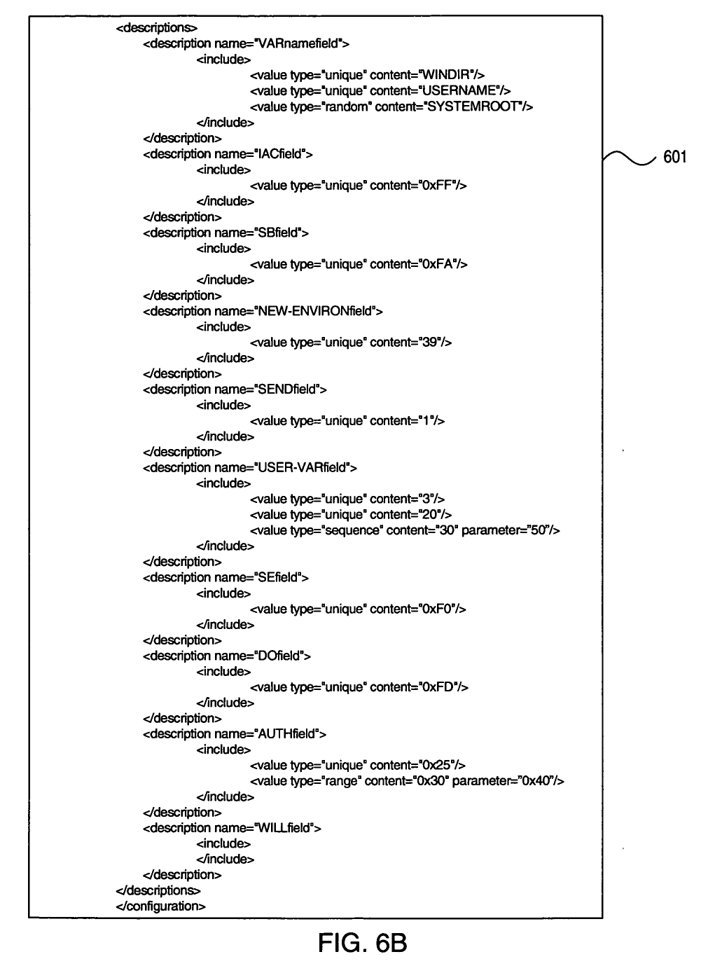

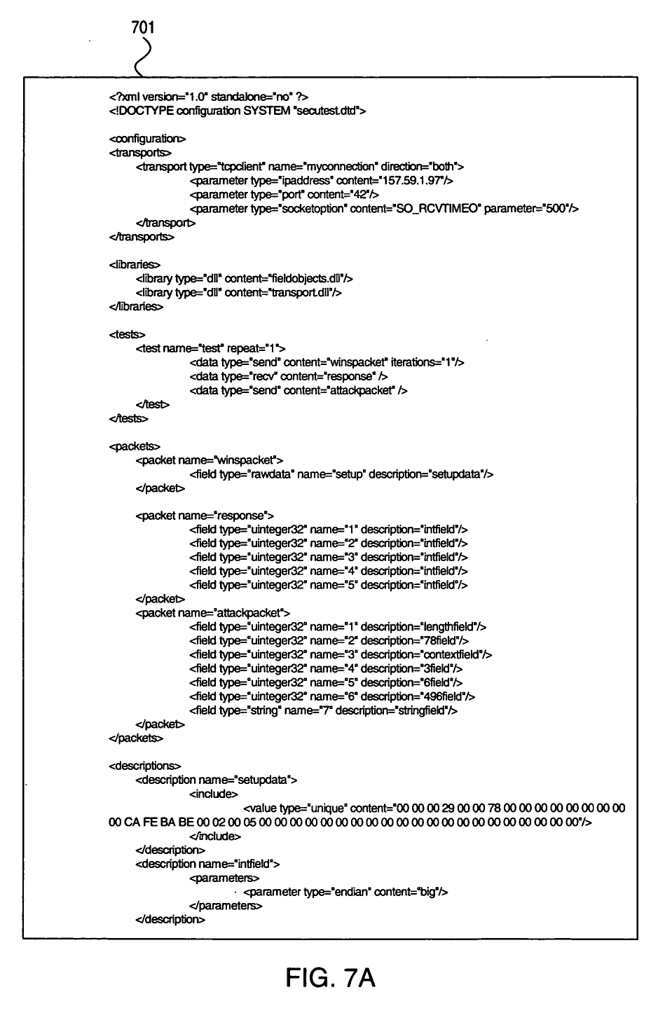

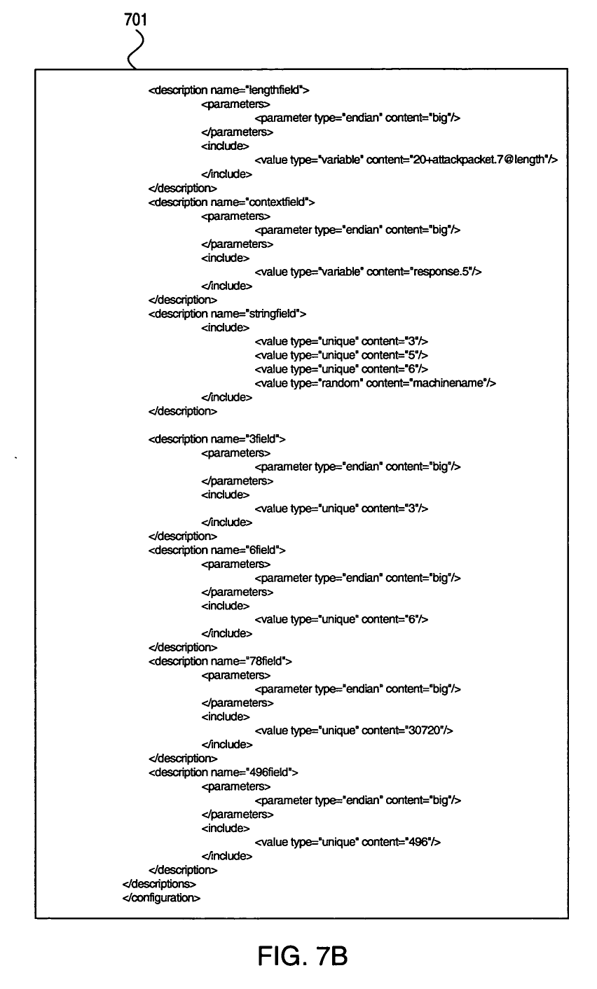

A document type definition (DTD) may be used to describe the format of the XML configuration file. FIG. 5 illustrates a sample DTD file 501 which may be used. FIG. 6A and FIG. 6B, taken together, illustrate a sample XML configuration file 601, using the DTD file 501 defined in FIG. 5, for a Telnet client test. FIG. 7A and FIG. 7B, taken together, illustrate another sample XML configuration file 701, again using the DTD file 501 defined in FIG. 5, for a WINS server attack test.

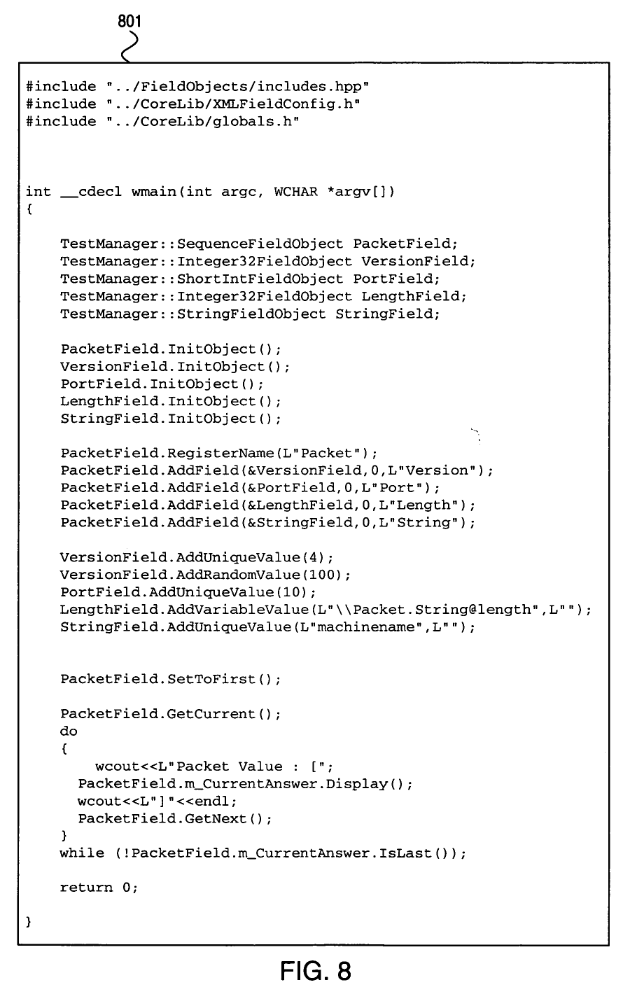

According to another aspect of the invention, a user or other tester may control the test manager 201 using an external executable program, e.g., a custom C++ executable, interacting with APIs exposed by field objects, transport objects, and the like. FIG. 8 illustrates a sample C++ executable 801 which may be used to control and perform a Test. Executable 801 creates a packet composed of four fields, sets different values in the fields, and then iterates through all the variations of the packet and displays them. A tester can access the value currently stored in a field by calling the m-CurrentAnswer member of the corresponding FieldObject. The tester, upon obtaining the current value, can use the value in any way in the test code.

According to another aspect of the invention, both an XML configuration file and an external executable program may be used in conjunction with each other. For example, the Tests section of the XML configuration file may alternatively be provided via the external executable program.

The present invention includes any novel feature or combination of features disclosed herein either explicitly or any generalization thereof. While the invention has been described with respect to specific examples including presently preferred modes of carrying out the invention, those skilled in the art will appreciate that there are numerous variations and permutations of the above described systems and techniques. Thus, the spirit and scope of the invention should be construed broadly as set forth in the appended claims.

What is claimed is:

1. One or more computer readable media storing a software framework for an extensible software debugging application, said framework comprising:
a plurality of field objects, each field object representing an instance of a data type usable with a target software; and
at least one transport object providing a type of communication channel for communicating a value of one or more of the plurality of field objects with the target software.

2. The computer readable media of claim 1, wherein a first field object of the plurality of field objects is usable for providing input to the target software, and a second field object of the plurality of field objects is usable for receiving output from the target software.

3. The computer readable media of claim 1, wherein a first field object comprises a test data value store for storing values to use during testing of the target software, a formatter for formatting each test data value as expected by the target software, and a field value storing a formatted current test data value.

4. The computer readable media of claim 1, said framework further comprising a configuration file defining the at least one transport object and the plurality of field objects, and further defining test values for each field object, and further defining at least one test to perform against the target software, wherein the test comprises a sequence of events, wherein each event sends or receives a field object over a transport object.

5. The computer readable media of claim 4, wherein the configuration file defines one or more libraries in which the plurality of field objects and the at least one transport object are stored.

6. The computer readable media of claim 1, wherein a first field object exposes at least one application programming interface (API) to allow a user to define one or more test data values of the data type corresponding to the first field object.

7. The computer readable media of claim 6, wherein the first field object comprises a randomizer object to create semi-random test values of the data type corresponding to the first field object, said semi-random test values based on one or more user-specified criteria via one or more APIs.

8. The computer readable media of claim 7, wherein the first field object exposes a first API to allow a user to add to a test value store of the first field object a specific test data value of the data type corresponding to the first field object, resulting in the specific test data value as well as at least one random test data value based on the specific test data value being added to the test value store.

9. The computer readable media of claim 7, wherein the first field object exposes a first API to allow a user to add to a test value store of the first field object a range of test data values of the data type corresponding to the first field object, resulting in at least boundary values at an upper end of the range, boundary values at a lower end of the range, a random value inside the range, a random value above the range, and a random value below the range being added to the test value store.

10. The computer readable media of claim 6, wherein the first field object exposes a first API to allow a user to add to a test value store of the first field object a specific test data value defined by a mathematical expression based on at least one other field object.

11. The computer readable media of claim 10, wherein the mathematical expression is based on a current value of the at least one other field object.

12. The computer readable media of claim 10, wherein the mathematical expression is based on a property value of the at least one other field object.

13. The computer readable media of claim 1, wherein said framework comprises a TCP client transport object, a TCP server transport object, and a named pipe client transport object.

14. The computer readable media of claim 1, wherein said framework comprises a signed integer field object, an unsigned integer field object, and a string field object.

15. The computer readable media of claim 1, wherein said framework comprises a sequence field object (SFO), said SFO representing a sequence of data fields.

16. A method for testing user input and output of a target software program, said method comprising steps of:
(a) defining two field object classes, each field object representing a data type usable with a target software; and
(b) defining a transport object providing a type of communication channel for communicating a value of one or more of the plurality of field objects with the target software.

17. The method of claim 16, further comprising:
(c) creating a first instance based on one of the two field object classes;
(d) creating a second instance based on one of the two field object classes;
(e) populating a field value in the first instance;
(f) performing a test on the target software using the first and second instances.

18. The method of claim 17, wherein step (f) comprises:
(i) communicating to the target software via the transport object the field value of the first instance;
(ii) storing an output value, received from the target software over the transport object, as a field value of the second instance.

19. The method of claim 18, further comprising:
(g) creating a third instance based on one of the two field object classes,
wherein step (f) further comprises (iii) calculating a field value of the third instance based on the second instance.

20. The method of claim 17, wherein the first field object class comprises a sequence field object, and wherein step (e) comprises populating a plurality of field values in the first instance.
